(19) United States
(12) Patent Application Publication
(10) Pub. No.: US 2020/0373813 A1
(43) Pub. Date: Nov. 26, 2020

(54) Integrated Motor Electronics

(71) Applicant: KSB SE & Co. KGaA, Frankenthal (DE)

(72) Inventors: Gerd EBELT, Frankenthal (DE); Federico DI SANTO, Ponte di Nanto (IT); Jochen MADES, Frankenthal (DE); Boris JANJIC, Frankenthal (DE)

(21) Appl. No.: 16/766,336

(22) PCT Filed: Nov. 12, 2018
(86) PCT No.: PCT/EP2018/080920

§ 371 Date: May 22, 2020

(30) Foreign Application Priority Data
Nov. 23, 2017 (DE) 10 2017 220 967.4

(51) Int. Cl. H02K 9/06; H02K 5/18

(52) U.S. Cl. CPC H02K 9/06; H02K 11/33; H02K 2213/12; H02K 5/18

(57) ABSTRACT

An electrical motor arrangement includes and electric motor having a frequency converter. The components of the electronics of the frequency converter are distributed among a plurality of modules, the modules are electrically connected to each other, and the individual modules are arranged radially on the motor and each have an individual closed housing in the mounted state. A cooling arrangement may be provided in which a fan causes a heat-dissipating air stream to pass over the modules and cooling fins arranged between adjacent modules to dissipate heat from the electric motor stator.

### CROSS REFERENCE TO RELATED APPLICATIONS

This application is a continuation of PCT International Application No. PCT/EP2018/080920, filed Nov. 12, 2018, which claims priority under 35 U.S.C. § 119 from German Patent Application No. 10 2017 220 967.4, filed Nov. 23, 2017, the entire disclosures of which are herein expressly incorporated by reference.

### BACKGROUND AND SUMMARY OF THE INVENTION

The invention relates to integrated electronics in an electric motor, and to a kit composed of individual electronic components for integration in an electric motor.

Electric motors of the design according to the invention are used, for example, in conveying devices, centrifugal pumps and/or processing devices. These in turn play a significant role in production systems. Within such systems, the electric motors according to the invention can be used at different locations, wherein the accessibility is in some cases possible in a very limited fashion.

For the energy-efficient operating mode, the abovementioned uses are driven by regulated electric motors. The regulation of the drives requires additional installation space in a system or complex switching cabinets in the close proximity of the system.

DE 10 2005 032 964 A1 presents a converter motor which has the entire power electronics arranged within the motor housing.

DE 10 2005 032 966 A1 also presents a converter motor, wherein an external fan is provided for the dissipation of heat.

Converter motors with electronic components which are provided in or on the housing of the motor are sufficiently known. All the motors have a fixed arrangement of the individual components and designated insulation directions.

The invention is then based on the object of developing a converter motor which is simple and cost-effective to manufacture and in which the flexibility is significantly increased.

The object is achieved by an electric motor having a frequency converter as claimed in claim 1, in which the components of the electronics of the frequency converter are arranged and distributed among a plurality of modules, wherein the individual modules are electrically connected, wherein a fan is provided on the electric motor, wherein the electronic circuit boards of the various modules are located in a plurality of separate housings, wherein each housing is arranged radially on the outer circumference of the electric motor, in that the cooling airstream of a fan dissipates the heat of the modules and motor.

Each module in itself forms a separate closed-off unit comprising an electronic component, for example a circuit board in a housing which is provided with electrical connections. One module is electrically connected to the other modules. The arrangement on the outer circumference of the motor housing ensures, on the one hand, that the heat of the individual modules can be sufficiently dissipated, and on the other hand the modules are easily accessible so that when servicing is required the modules can be easily accessed. In particular, the modules can be arranged in a flexible way so that a module with specific properties can be arranged, for example, in a system on a motor in such a way that direct access to the module is possible.

The invention can be configured in such a way that the modules comprises, for example, motor-side power electronics, power-system-side power electronics or a human-machine interface, that is to say is of modular design. This has the advantage that the individual modules can be arranged in a flexible way on the outer circumference of the motor. For example, the module can be arranged with the man-machine interface in such a way that simple use is possible. Furthermore, a module with a power element in which waste heat possibly occurs to an amplified extent can be provided at a location at which heat can be dissipated in a simplified fashion.

In a further refinement, the closed-off housings of the individual circuit boards are uniform in terms of their external form independently of their content. This additionally simplifies the modular concept in that the individual modules with identical external dimensions can be interchanged as desired. The electrical connection is particularly advantageously provided in such a way that the modules can be exchanged as desired at any time even in the case of a completely mounted converter motor.

In a further refinement of the invention, regions for attaching the housings comprising one or more circuit boards, preferably three regions, are preferably provided on the housing of the electric motor, wherein cooling fins for dissipating the heat of the stator of electric motor can be provided between the regions. In order to accommodate the individual modules, these regions ought to be configured identically such that the module can be spatially integrated and that a thermal connection can be made to the motor, wherein the input of the motor and of the respective module has to be taken into account.

A further refinement, the electric motor is covered by a motor cover. Said cover serves, inter alia, to guide a cooling airstream for dissipating the heat of the motor and of the modules. For example, this motor cover can cover at least the regions in which the motor is equipped with cooling fins. In the converter motor according to the invention, these cooling fins can be configured rather generously, since as a result of the modules the motor requires slightly larger overall volume than a motor operated from a power system. Furthermore, it is also possible to configure the motor cover in such a way that the modules are located under it, wherein corresponding inspection openings are to be provided.

The motor cover itself can be configured in such a way that the airstream is preferably guided to specific regions.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first view of an electric motor according to an embodiment of the invention,

FIG. 2 shows a second view of an electric motor according to an embodiment of the invention, and

FIG. 3 shows a third view of an electric motor according to an embodiment of the invention.

### DETAILED DESCRIPTION OF THE DRAWINGS

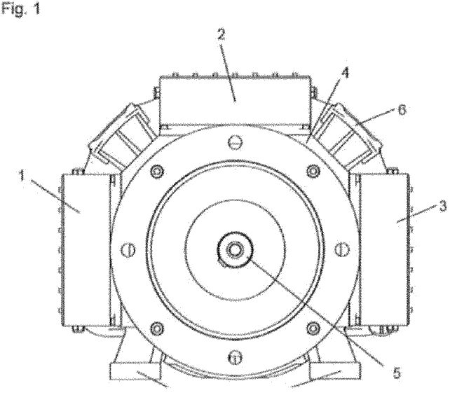

FIG. 1 shows a first view of an electric motor according to the invention in an axial plan view. The electric motor 4 has a flanged connection possibility which is indicated in FIG. 1, in the center of which the drive shaft 5 is illustrated with a further key. The individual modules of the motor electronics, a module comprising a human-machine interface (HMI) 1, a further module comprising the motor-side power electronics 2 and a third module comprising the power-system-side power electronics 3 are arranged radially around the stator of the electric motor 4.

FIG. 1 shows further parts of the motor cover 6 which cover a number of cooling fins of the motor housing in this illustration, and the housing feet 7, with which the electric motor 4 can be fastened in a system.

For example, a simple display which displays motor data such as the parameterization of the converter motor or current measured values on the running motor is suitable as an HMI 1 for each motor according to the invention. For this purpose it is also possible to provide control possibilities using switches, in particular using a touch-sensitive display. However, it is also possible to provide an interface to a remote display and/or control device. In addition to cable connections, infrared links or radio links are also suitable for this.

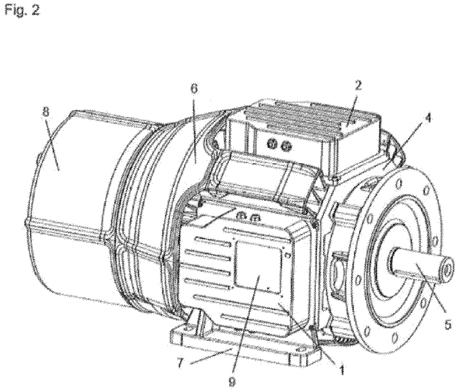

FIG. 2 shows an oblique view of the entire motor assembly comprising the electric motor 4, the modules of the motor electronics 1, 2 and 3, the drive shaft of the motor 5, the motor cover 6, the housing feet 7 and a fan 8. The fan 8 can be embodied as a motor-shaft-mounted fan or as an external fan. A display 9 by which information can be output to the user is illustrated at the human-machine interface 1. In the case of a touch-sensitive display 9, inputs for controlling the function of the motor assembly could also be made.

Various line feedthroughs are provided on the closed housing of the module for the human-machine interface 1. Plug-type connections can also be provided on said feedthroughs.

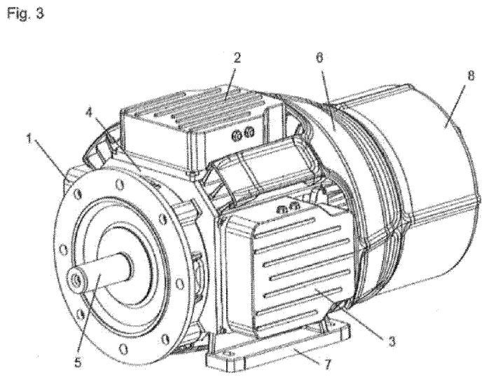

FIG. 3 shows the motor assembly from the two previous figures from a further prospective. The power-system-side power electronics 3 which are now present at the front have a fixed housing in which various line feedthroughs are provided, wherein the power system connection is made through such a feedthrough. Furthermore, lines can lead from additional external sources into the modules, for example sensors or control lines, in particular bus lines or else supply lines for further actuators, in particular external fans which can also be controlled by the motor assembly. Plug-type connectors can also be provided on the line feedthroughs.

The separation of the power-system-side and motor-side power electronics permits modular adaptation to the respective needs of an application. Thus it is possible for different mains voltages or frequencies to be modeled by different modules, and likewise the motor-side actuation of different motor types can be modeled. Furthermore, all the field bus systems can be easily modeled in the modules.

It is particularly servicing-friendly for the configuration of a system if individual modules can be adapted to the local conditions as desired.

Since the modules 1, 2 and 3 have a uniform structure and connection design, the module which comprises the motor-side power electronics 2 is also provided in a closed housing, wherein the latter has a plurality of line feedthroughs.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE NUMBERS

1 Human-machine interface
2 Motor-side power electronics
3 Power-system-side power electronics
4 Electric motor
5 Drive shaft
6 Motor cover
7 Housing feet
8 Fan
9 Display

1-12. (canceled)

13. An electric motor arrangement, comprising:
an electric motor; and
a frequency converter having electronic components distributed among a plurality of modules are arranged radially on the electric motor,
wherein in a mounted state on the electric motor, the plurality of modules are electrically connected and a housing of each the plurality of modules is closed-off.

14. The electric motor arrangement as claimed in claim 13, wherein
in an unmounted state the housings of the plurality of modules are closed-off.

15. The electric motor arrangement as claimed in claim 13, wherein
the plurality of modules have plug-type connections.

16. The electric motor arrangement as claimed in claim 13, further comprising:
a fan arranged to cause a heat-dissipating cooling air stream to pass over the surfaces of plurality of modules.

17. The electric motor arrangement as claimed in claim 13, wherein
at least one module of the plurality of modules includes motor-side power electronics.

18. The electric motor arrangement as claimed in claim 17, wherein
at least one module of the plurality of modules includes power-system-side power electronics.

19. The electric motor arrangement as claimed in claim 18, wherein
at least one module of the plurality of modules includes a human-machine interface.

20. The electric motor arrangement as claimed in claim 13, wherein
the housings of the plurality of modules have the same shape.

21. The electric motor arrangement as claimed in claim 13, wherein
the plurality of modules includes three modules,
a housing of the electric motor includes three module-receiving regions, and
each of the module-receiving regions is configured to receive one of the plurality of modules.

22. The electric motor arrangement as claimed in claim 21, further comprising:
cooling fins configured to dissipate heat of a stator of the electric motor, the cooling fins being arranged in cooling fin regions of the electric motor housing between adjacent ones of the module-receiving regions.

23. The electric motor arrangement as claimed in claim 22, wherein
the cooling fin regions are covered by at least one motor cover.

24. The electric motor arrangement as claimed in claim 13, further comprising:
a fan arranged to cause a heat-dissipating cooling air stream to pass over the surfaces of plurality of modules; and
cooling fins configured to dissipate heat of a stator of the electric motor,
wherein
at least one module of the plurality of modules includes motor-side power electronics,
at least one module of the plurality of modules includes power-system-side power electronics,
at least one module of the plurality of modules includes a human-machine interface the housings of the plurality of modules have the same shape,
the plurality of modules includes three modules,
a housing of the electric motor includes three module-receiving regions,
each of the module-receiving regions is configured to receive one of the plurality of module, and
the cooling fins are arranged in cooling fin regions of the electric motor housing between adjacent ones of the module-receiving regions.
